(19) United States
(12) Patent Application Publication
(10) Pub. No.: US 2002/0128919 A1
(43) Pub. Date: Sep. 12, 2002

(54) Order processing system

(76) Inventors: Cedric-Gaya Rime, Bossonnens (CH); James-Hamish Graham, Corminboeuf (CH); Pascale Bessire, Vauderens (CH)

Correspondence Address: BEYER WEAVER & THOMAS LLP, P.O. BOX 778, BERKELEY, CA, 94704-0778, US

(21) Appl. No.: 09/800,965

(22) Filed: Mar. 6, 2001

(51) Int. Cl. G06F 17/60

(52) U.S. Cl. 705/26

(57) ABSTRACT

A method for processing an order within a network includes receiving an order at an initial gateway, where the order has a plurality of fields associated therewith. A chain of a plurality of gateways for processing at least a portion of the order is then ascertained. More particularly, the chain of gateways identifies a sequence in which the gateways are configured to process the order. A first gateway in the chain of gateways is identified, where the first gateway is adapted for processing a first set of one or more fields of the order. In addition, a second gateway in the chain of gateway is identified, where the second gateway is adapted for processing a second set of one or more fields of the order. The first set of fields is passed to the first gateway and the second set of fields is passed to the second gateway, thereby enabling the first and second gateways to separately process at least a portion of the order.

### BACKGROUND OF THE INVENTION

1. Field of the Invention

The present invention relates to methods and apparatus for processing orders. More particularly, the present invention relates to methods and apparatus for processing a single order in a distributed manner.

2. Description of the Related Art

When an order is received by a business, the business fills the order from its available inventory. During this process, the items ordered are packaged and shipped to the customer. The customer is then billed for the order. Accordingly, order processing is a fairly simple process when an order is filled from a single warehouse location.

While processing an order is an uncomplicated process when the order is filled from a single location, in practice, there are many situations where this is not the case. Businesses often manufacture products in geographically separated facilities and therefore store these products in warehouses that are also in different geographical locations. When a customer orders multiple items that must be obtained from these different geographical locations, the process of filling an order has the potential to become a time-consuming and inefficient one.

In today's Internet savvy society, geographically separated business locations often communicate via a computer network. Thus, when multiple items specified in a single order must be filled from multiple warehouse locations, the order is typically transmitted to these different locations. While the Internet offers a viable means for communicating between geographically separated business locations, the manner in which orders are processed continues to be a time-consuming one. For example, within each warehouse location there are often numerous departments through which a single order must be processed. For instance, many businesses have different departments for purposes of packaging, shipping, and billing. In addition to identifying the items ordered by the customer, the order therefore typically includes information that will be used to process the order such as address and credit card information. Rather than divide the order for processing by the different warehouse locations and departments, the order is typically processed sequentially as a single entity. As a result, an order specifying numerous items and/or requiring numerous processing steps has traditionally taken a substantial amount of time to fill.

In view of the above, it would be desirable to enable orders to be processed in a more efficient manner. More particularly, improved mechanisms for processing a single order in a distributed fashion are needed.

### SUMMARY OF THE INVENTION

The present invention enables an order to be processed in a distributed manner within an order processing system. For purposes of this application, the term “gateway” will be used to denote a point in such an order processing system, a step that is performed in the order processing system, or a processing element that is capable of performing such a step. For example, a processing element may be a computer or CPU.

Multiple gateways may be “interconnected” and configured for processing of an order in a variety of ways in accordance with a business' specifications. These gateways may be described as a “chain” of gateways that are interconnected for purposes of processing orders. Alternatively, this chain may be described as identifying a sequence in which the gateways are configured to process the order. For example, the chain of gateways may include two or more “branches” that are capable of processing the order in parallel.

The present invention enables an order to be processed in a distributed manner, in part, through the use of a plurality of gateways that each process at least a portion of the order. In this manner, an order may be “split” to enable the order to be processed in parallel by multiple gateways (e.g., located at geographically separated sites). In this manner, the present invention enables an order to be processed more efficiently than traditional order processing methods.

In accordance with one aspect of the invention, two different gateways in a chain of gateways separately process at least a portion of a single order. More particularly, a method for processing an order within a network comprises receiving an order at an initial gateway, where the order has a plurality of fields associated therewith. A chain of a plurality of gateways for processing at least a portion of the order is then ascertained. More particularly, the chain of gateways identifies a sequence in which the gateways are configured to process the order. A first gateway in the chain of gateways is identified, where the first gateway is adapted for processing a first set of one or more fields of the order. In addition, a second gateway in the chain of gateway is identified, where the second gateway is adapted for processing a second set of one or more fields of the order. The first set of fields is passed to the first gateway and the second set of fields is passed to the second gateway, thereby enabling the first and second gateways to separately process at least a portion of the order.

In accordance with another aspect of the invention, a gateway in a chain of gateways processes a portion of the order only when the conditions associated with the gateway have been fulfilled. More particularly, a computer-implemented method for processing an order within a network comprises receiving an order at an initial gateway, the order having a plurality of fields. A chain of a plurality of gateways for processing the order is ascertained, the chain of gateways identifying a sequence in which the gateways are configured to process at least a portion of the order. A gateway in the chain of gateways that is adapted for processing a set of one or more fields of the order is identified. The gateway has an associated set of one or more conditions that must be fulfilled prior to passing the associated set of fields to the identified gateway. It is then determined whether the conditions associated with the identified gateway are fulfilled. When it is determined that the conditions associated with the identified gateway are fulfilled, the set of fields is passed to the identified gateway, thereby enabling the identified gateway to process at least a portion of the order.

In accordance with another aspect of the invention, a process manager determines those gateways that are available for processing at least a portion of the order prior to passing the appropriate order information to those gateways. A computer-implemented method for processing an order within a network comprises receiving an order at an initial gateway, the order having associated order information. A chain of a plurality of gateways for processing the order is ascertained, where the chain of gateways identify a sequence in which the gateways are configured to process at least a portion of the order. Gateway information associated with the chain of gateways is examined to identify one or more gateways that are available for processing. At least a portion of the order information is then passed to the identified available gateways, thereby enabling the identified available gateways to process at least a portion of the order.

In accordance with yet another aspect of the invention, the present invention includes an acknowledger that updates gateway information in association with a processing gateway to indicate those gateways that have completed processing as well as those gateways that are waiting to be called. More particularly, a computer-implemented method for processing an order by a receiving gateway within a network comprises obtaining gateway information associated with an order. The gateway information preferably indicates a status for one or more linked gateways, the status indicating whether the linked gateway is available for processing upon completion of processing of an associated processing gateway. A set of conditions associated with each of the linked gateways is examined to identify one or more of the linked gateways that are available for processing. The gateway information associated with the processing gateway and the linked gateways that are available for processing is then updated.

These and other features of the present invention will be described in more detail below in the detailed description of the invention and in conjunction with the following figures.

### BRIEF DESCRIPTION OF THE DRAWINGS

FIG. 1 is a process flow diagram illustrating a distributed order process and exemplary conditions that may be used to “split” an order in accordance with one embodiment of the invention.

FIG. 2 is a process flow diagram illustrating the use of location and order item to “split” an order within the distributed order process in accordance with one embodiment of the invention.

FIG. 3A and FIG. 3B are diagrams illustrating an exemplary order in accordance with one embodiment of the invention.

FIG. 4 is an exemplary diagram illustrating the use of conditions to control the flow of order information to associated gateways.

FIG. 5 is a diagram illustrating an exemplary gateway flow in accordance with the satisfaction of conditions associated with the gateways.

FIG. 6 is a diagram illustrating exemplary gateway tables that are used to track the status of gateways in accordance with one embodiment of the invention.

FIG. 7 is a block diagram illustrating software modules that may be used to implement the present invention.

FIG. 8 is a process flow diagram illustrating one method of implementing the process manager illustrated in FIG. 7.

FIG. 9 is a process flow diagram illustrating one method of implementing the marshaller shown at block 808 of FIG. 8.

FIG. 10 is a process flow diagram illustrating one method of implementing a gateway called by the process manager.

FIG. 11 is a process flow diagram illustrating one method of implementing the acknowledger shown at block 1006 of FIG. 10.

FIG. 12 is a diagram illustrating an exemplary system in which the present invention may be implemented.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

The present invention enables a single order to be “split” to enable the order, or portion thereof, to be processed in parallel by multiple entities. As one example, different portions of the order may be processed in parallel by different business locations that are geographically separated. As another example, separate portions of the order may be processed in parallel by different departments within a single business location.

It may be desirable to “distribute” a single order among a plurality of gateways to accomplish a variety of purposes. For instance, as described above, it may be desirable to process the same order within different warehouse locations and/or departments. Similarly, it may be desirable to “split” an order in accordance with functions that are performed for various billing methods. For example, different authorization functions must be performed for credit card purchases that need not be performed for purchases made by check. As another example, it may be desirable to provide free gifts or advertisements that are directed to a customer based upon a customer profile and/or type of items ordered.

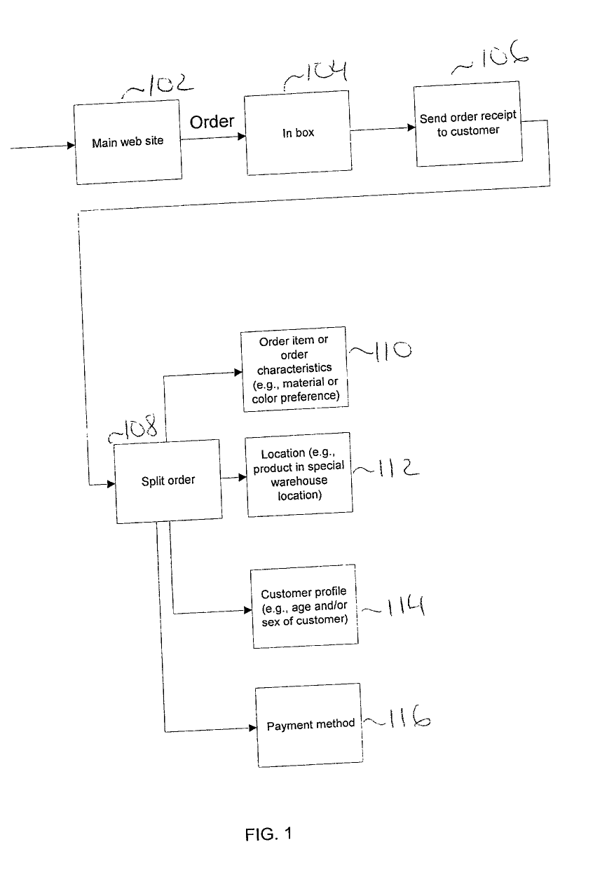

The manner in which an order is “split” at various points within an order processing system may be specified by one or more conditions. For example, a condition may specify that a particular gateway is to process at least a portion of the order when the order is to be billed to a credit card. FIG. 1 is a process flow diagram illustrating a distributed order process and exemplary conditions that may be used to “split” an order in accordance with one embodiment of the invention. As shown, an order is received from a customer via a main web site 102. For instance, the main web site 102 may be a web site maintained for a plurality of business or, alternatively, may be dedicated to a single business. Once the order is received, the order is sent to an initial gateway (i.e., inbox) 104 for distribution to the appropriate gateways. In order to inform the customer that its order is being processed, an order receipt message is sent to the customer at block 106.

At one or more gateways within the order processing system, a single order is split 108 to enable multiple gateways to simultaneously process at least a portion of the order. It is important to note that this order “splitting” can occur at multiple points within the processing of a single order. Since these gateways simultaneously process the order information received by them, the present invention enables a single order to be processed in an efficient manner.

In accordance with one embodiment of the invention, a chain of a plurality of gateways adapted for processing at least a portion of the order is identified. As described above, the chain of gateways identifies or represents a sequence in which the gateways are configured to process the order, and each gateway in the chain is “linked” to one or more of the plurality of gateways. More particularly, the gateways in the sequence of gateways may be configured to simultaneously process or sequentially process the order information received by them. In the example illustrated in FIG. 1, gateways 110, 112, 114, and 116 are configured to simultaneously process the order information received by them. Each of the gateways is configured for processing a specific set of order information (e.g., fields), which may be a subset of the order or equivalent to the entire order. For example, a gateway that is located in the billing department will require information that is necessary for billing the customer such as customer name, credit card number, expiration date, and total purchase amount. Moreover, the order information processed by each of the gateways 110, 112, 114, and 116 may be identical or different. For example, all gateways will need information that identifies the order (e.g., order number) while other information required by each gateway may differ. The order information that is required by each gateway may be identified by a “rule” associated with the particular gateway or may simply be parameters of the gateway.

Even when an order is “split,” some of the gateways will be configured for sequential processing while others will be configured for parallel processing. In accordance with the present invention, two or more gateways (e.g., 110, 112, 114, and 116) in the chain of gateways are identified (e.g., for parallel processing). More particularly, a first gateway (e.g., 110) has a first set of fields (e.g., parameters) associated therewith and a second gateway (e.g., 112) has a second set of fields (e.g., parameters) associated therewith. When a calling gateway calls these two gateways, the associated set of field values is passed as parameters to enable these gateways to separately process at least a portion of the order. It is important to note that the present invention enables parallel processing by multiple gateways. Thus, a single calling gateway may call the second gateway prior to completion of processing of the first set of fields by the first gateway. The calling gateway responsible for calling the multiple gateways may be the initial gateway (i.e., in box) 104 or one of the intermediate gateways (shown here as block 108). In this manner, two or more gateways may simultaneously process at least a portion of a single order.

Although order “splitting” may be performed automatically in order for simultaneous processing to occur, order “splitting” is preferably performed when a particular condition is fulfilled. For instance, one or more of the gateways may have an associated set of one or more conditions that must be fulfilled prior to passing the associated set of fields to the corresponding gateway. In the example shown in FIG. 1, four different exemplary conditions 110-116 may be used separately or in combination to trigger order splitting. As shown, the first condition 110 is triggered by a particular order item or order characteristics (e.g., material or color preference). This may be useful in a variety of instances. For example, the ordering of a particular item such as a baseball bat may trigger the sending of particular email advertisements to the customer such as those related to sports clothing or other sports paraphernalia. As another example, the ordering of a particular perfume may satisfy a condition to enable the web site to provide free gifts such as similarly scented bath oils to the customer. The second condition 112 is satisfied when the order (or portion thereof) is to be sent from a particular business or warehouse location. This may be important when a product may be provided from only a specific location or when the product is to be shipped from a location that is closest to the customer. For example, a snowboard may be manufactured and therefore shipped from a location in Japan while the bag for the board may be manufactured and shipped from the United States. Similarly, the third condition 114 presented in FIG. 1 is fulfilled when the order is obtained from a customer that satisfies a particular customer profile. For example, it may be desirable to process women between the ages of 18 and 30 separately in order to provide particular marketing messages or gift incentives to this particular customer group. As another example, the customer profile may simply be used to ensure that the appropriate shipping company be used for a particular customer. The fourth exemplary condition 116 pertains to a particular payment method. For instance, further verification is typically performed in association with a credit card payment.

Thus, when a customer makes a credit card payment selection, a gateway associated with the condition 116 may verify the credit card number and expiration date to ensure that the information identifies a valid credit card, as well as perform other verification procedures.

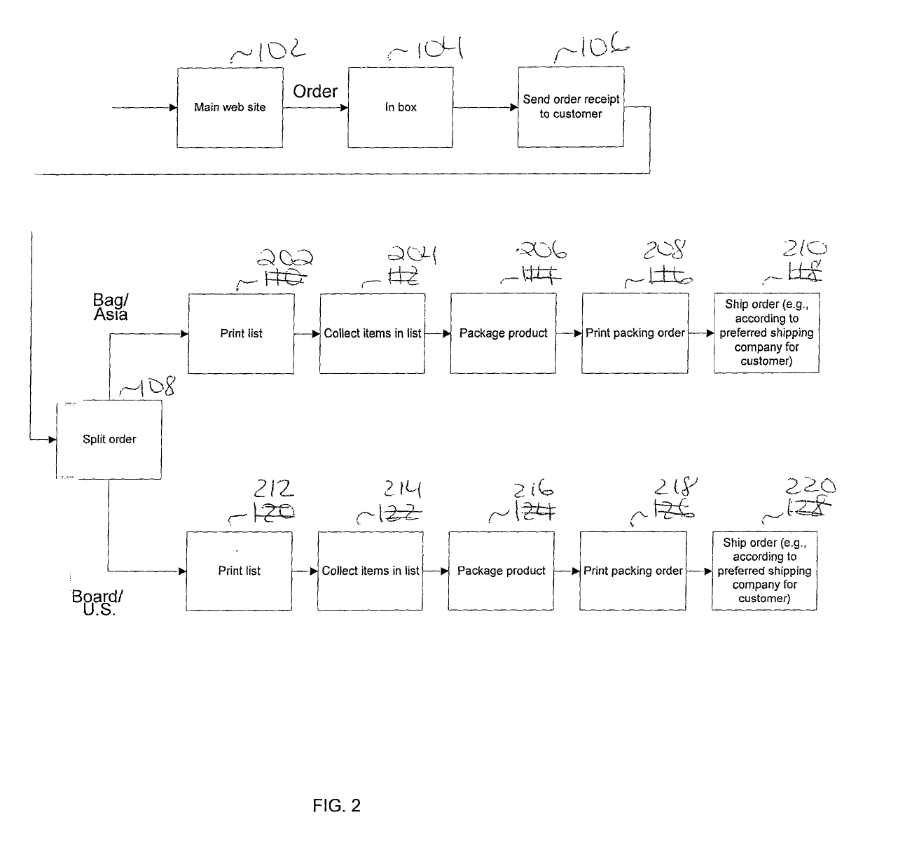

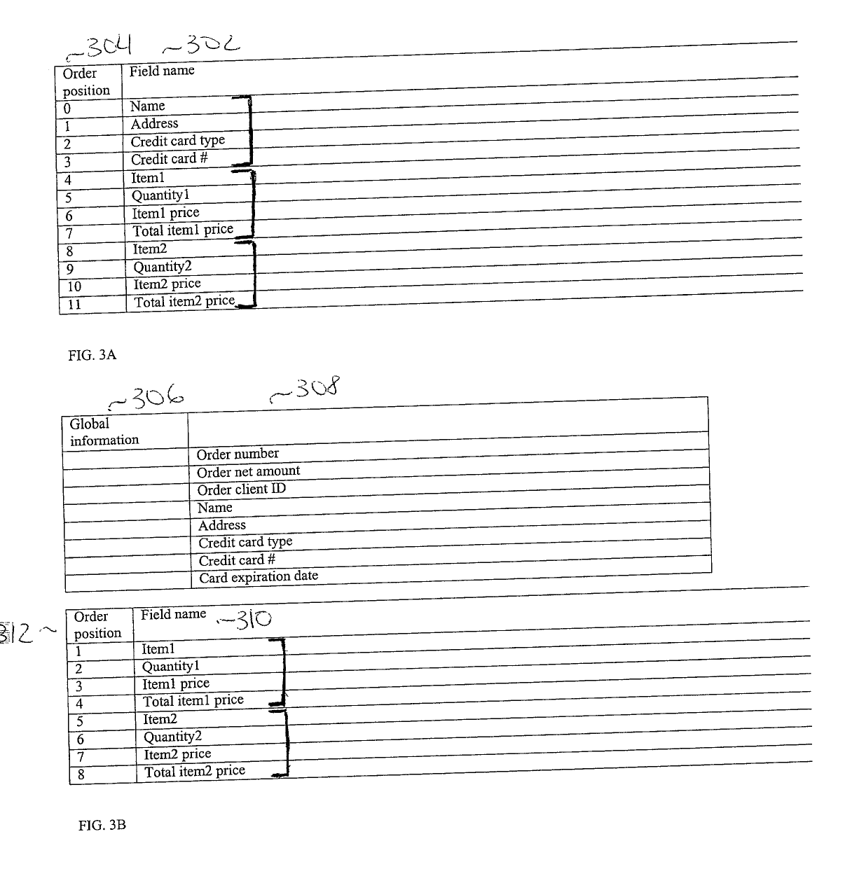

As described above with reference to FIG. 1, various conditions may be used to “split” an order for distributed processing of that order. Moreover, one or more conditions may be associated with each gateway to trigger the passing of order information to that gateway. FIG. 2 is a process flow diagram illustrating the use of location and order item to “split” an order within the distributed order process in accordance with one embodiment of the invention. Any number of gateways may each have an associated set of conditions that must be satisfied in order for that gateway to receive order information. In the example illustrated in FIG. 1, the location of the warehouse responsible for shipping the product and the order item to be shipped are presented as two separate items that may be used to separately satisfy a condition. In the example presented in FIG. 2, these two separate conditions may be applied in order to expedite processing of the order. More particularly, in this example, surf boards are shipped from a U.S. warehouse while bags for these boards are shipped from a warehouse in Asia. Thus, at block 108, when the item ordered is a bag, process blocks 202-210 are performed by a first set of gateways. However, when the item ordered is a board, process blocks 212-220 are performed by a second set of gateways. It may also be desirable to store both the bags and boards at both the Asia and U.S. locations and ship from either the Asia or U.S. warehouse depending upon the location of the consumer. Thus, the condition may match on the address of the customer rather than the item ordered. Of course, each condition may be triggered upon a variety of events. For instance, each condition may depend upon the content of the order. An exemplary order will be described in further detail below with reference to FIG. 3A and FIG. 3B.

FIG. 3A and FIG. 3B are diagrams illustrating an exemplary order in accordance with one embodiment of the invention. As shown in FIG. 3A, a field 10 indicator such as a field name 302 and/or order position 304 may be used to identify a field within an order. In this manner, the information from the order that is pertinent to a condition may be obtained. An order may include various fields including, but not limited to, name of customer, address of customer, credit card type, credit card number, and card expiration date. In addition, for each item ordered, an item, is quantity, price, and total item price may be obtained.

FIG. 3B also illustrates an exemplary order. In this example, the order information is divided as global information 306 that corresponds to a particular customer and non-global (dynamic) information that varies with each order. An exemplary set of fields 308 of an order that may be considered global information include, but are not limited to, order number, order net amount, order client ID, name, address, credit card type, credit card number, and card expiration date. Remaining fields of the order that are not considered global information may be identified by their field name 310 or associated order position 312. As shown, these fields include item, quantity, item price, and total item price. Other possible fields include a catalog identifier identifying a catalog from which the item(s) were selected, supplier discount offers (e.g., coupons or other discounts), supplier promotional information (e.g., dates on which one or more of the items is on sale at a discounted rate, tax rate, and shipping details (e.g., shipping company that is to be used to ship the order).

As described above with reference to FIG. 1 and FIG. 2, one or more conditions may be associated with any number of the gateways in the chain of gateways to trigger the flow of order information along the chain of gateways. For example, a condition may specify that a particular gateway is to process the order when the order quantity exceeds a specified amount. This may be useful since discounts may be offered when a particular quantity is ordered. Moreover, packaging may be performed in a different manner depending upon the quantity of items purchased.

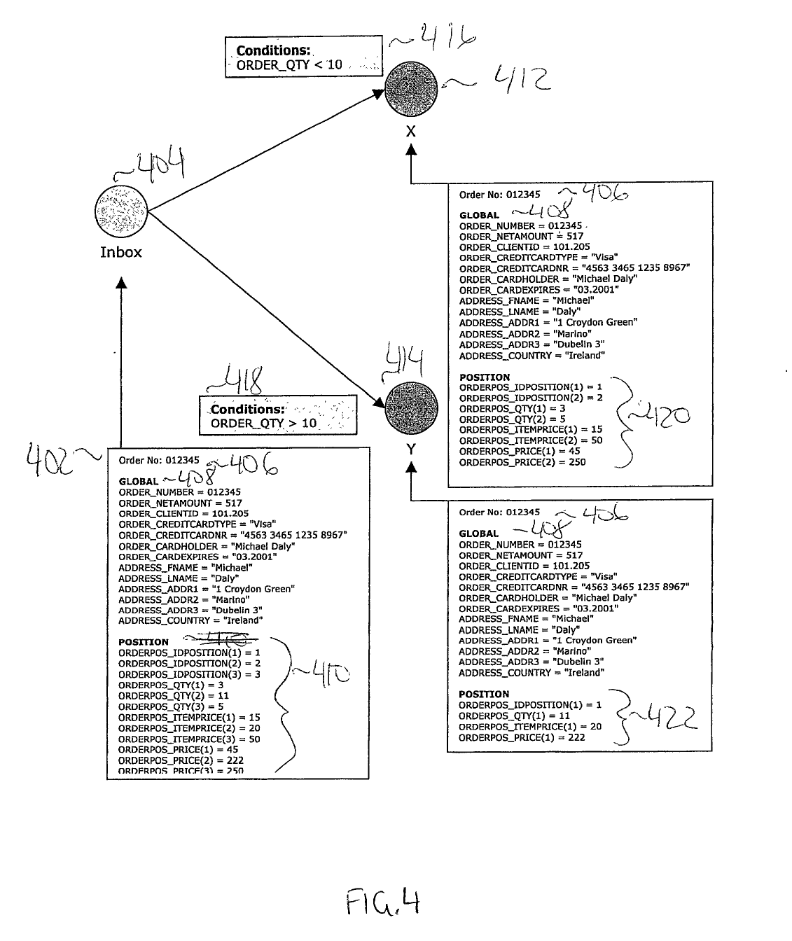

FIG. 4 is an exemplary diagram illustrating the use of conditions to control the flow of order information to associated gateways. As shown, an order 402 is received at in box 404. In order to identify the order among a plurality of orders, the order has an associated order number 406. In addition, the order includes global fields 408 as well as non-global fields 410, as described above with reference to FIG. 3B. In this example, conditions that are mutually exclusive are used to select the appropriate gateway to process the order. Thus, the order is processed by either a first gateway X (412) or a second gateway Y (414). In this example, the first gateway X (412) has an associated set of conditions 416 and the second gateway Y (414) has an associated set of conditions 418. More particularly, when the order quantity is less than 10, the appropriate order information is passed to the first gateway X (412). Here, the order information required by the first gateway X (412) includes the order number 406, the global information 408, and non-global fields 420 identified by their order position. When the order quantity is greater than 10, the appropriate order information is passed to the second gateway Y (414). The order information that is passed to the second gateway Y (414) includes the order number 406, the global fields 408, and non-global fields 422 identified by their order position. When a gateway does not have any associated conditions that must be fulfilled prior to passing parameter values to the gateway, these parameter values are passed automatically. Moreover, the parameter values are likely to include all fields in the order rather than specific fields when there are no conditions associated with a particular gateway.

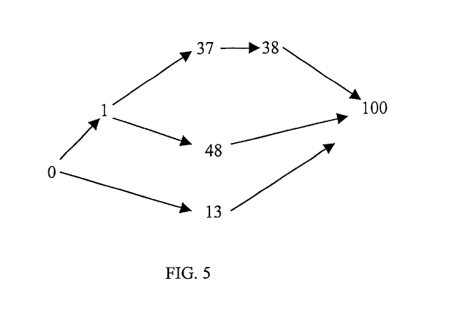

The use of conditions as shown and described with reference to FIG. 4 may be used to affect the gateway flow along the chain of gateways. FIG. 5 is a diagram illustrating an exemplary gateway flow in accordance with the satisfaction of conditions associated with the gateways. In this example, each gateway is represented by a different number. Here, gateway 0 represents the inbox. From the inbox, control is transferred to gateways 1 and 13. Gateway 1 calls both gateways 37 and 48. Gateway 37 then calls gateway 38. Gateways 38, 48 and 13 each call gateway 100, which is at the end of the chain of gateways. Thus, a condition may be used in association with gateway 100 to indicate that gateway 100 is to be called only when gateways 38, 48 and 13 complete processing. For example, a WAIT condition may be used to require that gateway 100 WAIT until gateways 38, 48, and 13 complete processing. For example, it may be desirable to postpone billing until items from all warehouse locations have been shipped. Thus, the WAIT condition may be used to require that a gateway wait for completion of processing of a set of one or more processing gateways. Accordingly, one or more gateways in the chain of gateways may have one or more conditions associated therewith that must be fulfilled prior to accessing the associated gateway. In addition, as shown, the processing of a single order ends at a final processing gateway (shown here as gateway 100).

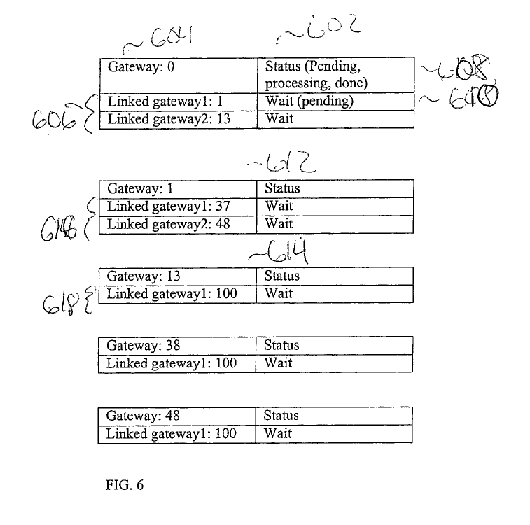

Each gateway within an order processing system has a particular processing status indicating the availability of that gateway for processing of the order. This status information will be monitored throughout the processing of the order to drive the order along the chain of gateways in an efficient manner according to the configuration of the system. Thus, gateway information associated with the chain of gateways indicates the processing status for each of the gateways. In accordance with one embodiment, the gateway information is represented in one or more gateway tables. FIG. 6 is a diagram illustrating exemplary gateway tables that are used to track the status of gateways in accordance with one embodiment of the invention. As shown, each gateway table 602 associates a gateway 604 with one or more linked gateways 606 that are configured for processing upon completion of processing by the gateway 604. In addition, each of the linked gateways 606 is associated with a status 608 indicating that the gateway is pending, processing or done processing. Thus, the status 608 indicates whether the corresponding gateway is available for processing.

More particularly, in order for a gateway to be available for processing, it must either (1) have no conditions that must be fulfilled prior to accessing the gateway or (2) have one or more conditions that are fulfilled. For instance, in this example, a wait (i.e., pending) status 610 indicates that the corresponding gateway is available to be called by a calling gateway. Moreover, the gateway identified with the gateway table may also have a status associated therewith (not shown).

In addition to representing the processing status of the gateways, the chain of gateways may also be represented by one or more gateway tables. For example, each of the gateways illustrated in FIG. 5 may each have an associated gateway table. In the first gateway table 602, gateway 0 is shown to have two linked gateways 606, 1 and 13. Gateways associated with each of the linked gateways 1 and 13 are associated with second and third gateway tables 612 and 614, respectively. More particularly, in the second gateway table 612, gateway 1 is identified with two linked gateways 616, 37 and 48. Similarly, in the third gateway table 614, gateway 13 is identified with a single linked gateway 618, 100. Of course, a gateway such as the final gateway (gateway 100) will not have any linked gateways that are accessible. Therefore, a gateway table may identify zero or more linked gateways. Accordingly, an entire chain of gateways may be represented by one or more gateway tables.

The present invention is preferably implemented in multiple software modules to enable the modules to be easily updated. FIG. 7 is a block diagram illustrating software modules that may be used to implement the present invention in accordance with one embodiment of the invention. A process manager 702 receives an order at the web server, stores order information for the received order and assigns a process ID to the order. In addition, the process manager calls a marshaller 704 that is primarily responsible for “marshalling” the appropriate gateways for processing of the order. More particularly, the marshaller 704 is responsible for sweeping gateway tables such as those illustrated in FIG. 6 to identify one or more gateways to process the order, passing the appropriate gateway table (as well as the appropriate order fields) to available pending gateways, and marking the status of these gateways as processing. An acknowledger 706 is responsible for updating databases such as order information and gateway tables upon completion of processing of a called gateway. More particularly, when a gateway modifies data, this data is recorded in the appropriate database(s). In addition, the status of the current processing gateway is changed to “done”. In this embodiment, the acknowledger is also responsible for checking whether conditions associated with each linked gateway are fulfilled in order to determine whether the gateway is to be accessed. For each gateway to be accessed, the acknowledger creates a new gateway table and marks the status of the gateway as pending. In accordance with one embodiment, the acknowledger 706 is called by a gateway 708 that has completed its processing when called by the process manager 702. Alternatively, the process manager 702 may call the acknowledger 706. The order information for each order, customer information, gateway tables and other information may be stored in one or more databases 710.

A business may wish to customize the order processing system. Thus, a customizer 712 may be used by a business to customize various aspects of the order processing system. For instance, the configuration of the chain of gateways may be defined through the customizer module 712. Thus, the chain of gateways is modifiable rather than static for each business. Accordingly, the chain of gateways may be defined by a business through which the order is to be processed. In this manner, a business may define the functions performed as well as the order in which these functions are to be performed.

In addition to modifying the configuration of the gateways, conditions associated with each gateway may be established through the customizer module 712. More particularly, the customizer module 712 may be used to define each set of conditions. Since each set of conditions is modifiable, a business through which the order is to be processed may define as well as modify each set of conditions. Accordingly, the customer may control the flow of information to the gateways in accordance with a specific business plan. In addition, the customer may wish to interface the order processing system of the present invention with an on-line catalog system as well as conventional accounting and billing software systems to receive and process orders that are received via the Internet.

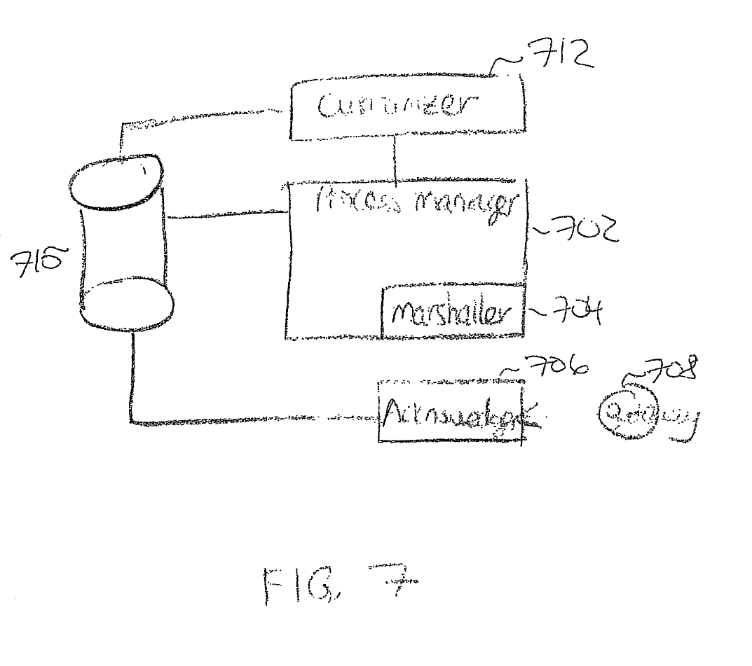

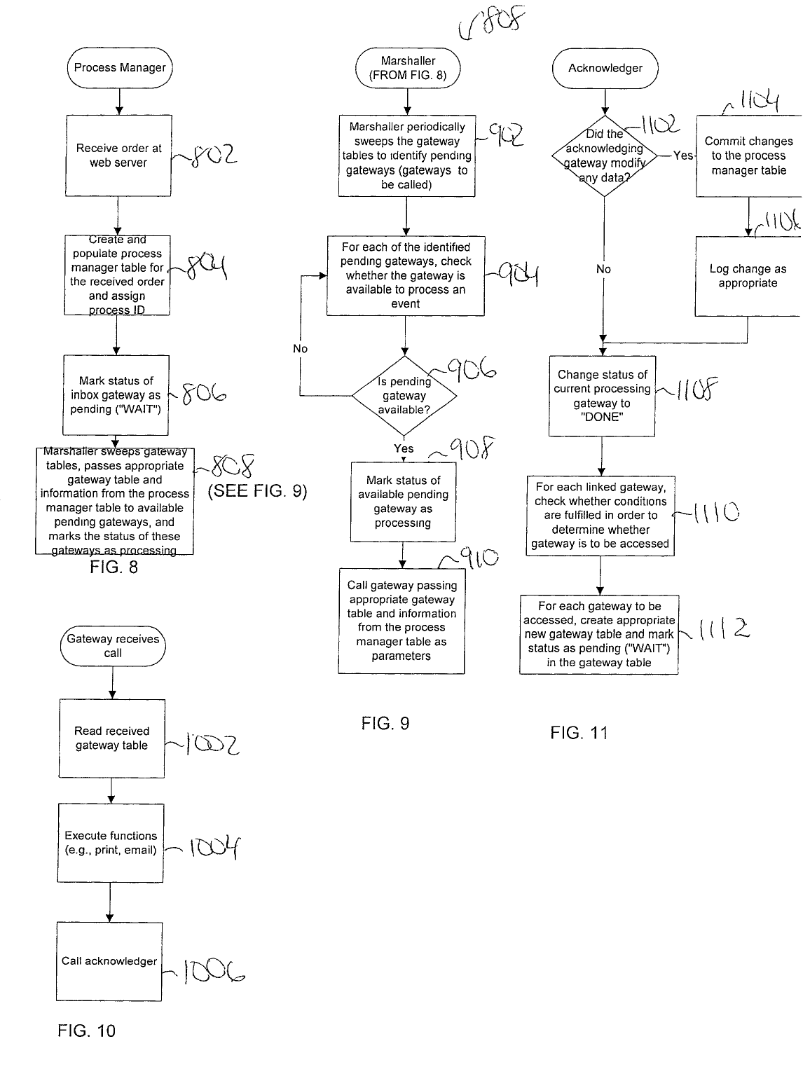

As described above with reference to FIG. 7, the process manager is responsible for determining which gateways are pending (i.e., waiting to be called) and calling these gateways. FIG. 8 is a process flow diagram illustrating one method of implementing the process manager illustrated in FIG. 7. As shown at block 802, when a customer submits an order, the order is received at a web server. Order information associated with the order is then stored in one or more databases and a process ID is assigned to the order at block 804. More particularly, a process manager table storing information such as that illustrated in FIG. 3B may be populated with the order information obtained from one or more databases. For instance, the global information 306 shown in FIG. 3B may be obtained from one or more tables containing data that is pertinent to the customer as well as other static information, while the non-global information may be obtained from one or more tables that store the dynamic order information.

Once the information that is pertinent to the order is obtained and stored for processing by the chain of gateways, the status of the in box gateway is marked as pending at block 806. Through the association of a pending status with the initial gateway, this signals that the order information received by the initial gateway is ready to be processed and therefore the initial gateway is ready to be “called” by the marshaller. As shown at block 808, the marshaller is responsible for directing the appropriate information to the appropriate gateways for processing of the order. As described above, a chain of gateways may be represented by a plurality of gateway tables. In addition, gateway information regarding the status of these gateways may be stored in the gateway tables. From this gateway information obtained from the gateway tables, the marshaller identifies one or more available gateways. More particularly, in accordance with one embodiment, a gateway is available if it has a pending status and is available to process an event. The appropriate order information is then passed to the identified available gateways, thereby enabling these gateways to process at least a portion of the order. In addition to passing order information (e.g., from the process manager table) to the identified gateways, the marshaller also passes the appropriate gateway information (e.g., gateway table) to each of these identified gateways. The status of these gateways is then marked as processing.

FIG. 9 is a process flow diagram illustrating one method of implementing the marshaller shown at block 808 of FIG. 8. As described above, the marshaller examines gateway information associated with the chain of gateways to identify one or more gateways that are available for processing. More particularly, as shown at block 902, the marshaller periodically sweeps the gateway tables to identify one or more gateways having a pending status. For each of the identified pending gateways, the marshaller then determines whether the gateway is available to process an event at block 904. If it is determined at block 906 that the pending gateway is available to process an event, the status of the available pending gateway is marked as processing at block 908. The gateway is then called at block 910. In addition, the gateway table associated with the gateway and the appropriate order information are passed to the gateway. For instance, once the parameters of the gateway are ascertained, the parameter values may be obtained from the process manager table and passed to the gateway.

FIG. 10 is a process flow diagram illustrating one method of implementing a gateway called by the process manager. In accordance with one embodiment, gateway information associated with one or more linked gateways is passed to the gateway. More particularly, when the gateway is called, it reads the gateway table passed to it as shown at block 1002. In addition, the gateway receives any parameters obtained from the process manager table that it requires for processing. More particularly, the gateway executes various functions and procedures at block 1004. Depending upon the specific functions performed by the gateway, it will require different information from the process manager table. For instance, the gateway may be responsible for verifying credit card information, printing an invoice, or emailing a customer an order receipt message. In order to perform these specific functions, the gateway will therefore require the corresponding credit card information and/or customer information. Once these processes have been completed, the acknowledger is called at block 1006.

The acknowledger is primarily responsible for updating the gateway information (e.g. gateway tables) and the order information (e.g., process manager table) with respect to the previously processing gateway as well as with respect to the gateways that are “linked” to the processing gateway. While the acknowledger may be called by the processing gateway as shown at block 1006 of FIG. 10, the acknowledger may also be called by the process manager upon completion of processing of the gateway (e.g., after block 910 of FIG. 9).

FIG. 11 is a process flow diagram illustrating one method of implementing the acknowledger shown at block 1006 of FIG. 10. At block 1102, the acknowledger determines whether the gateway modified any data (i.e., order information). If any order information was modified, modified order information is stored in the appropriate databases (e.g., process manager table) at block 1104 and these changes are logged as appropriate at block 1106. The process continues at block 1108 where the status of the current processing gateway is modified to “DONE”. For each linked gateway, the gateway tables are created and modified as appropriate. More particularly, at block 1110 for each of the linked gateways in the gateway table (previously passed to the gateway), the acknowledger determines whether one or more conditions must be fulfilled prior to accessing the linked gateway and whether these conditions are fulfilled. For each gateway to be accessed, a new gateway table is created and the status of the linked gateway is marked as pending (“WAIT”) at block 1112. More particularly, a linked gateway is a gateway to be accessed in two instances: (1) the linked gateway does not have any conditions associated therewith; or (2) the linked gateway has one or more associated conditions that are fulfilled.

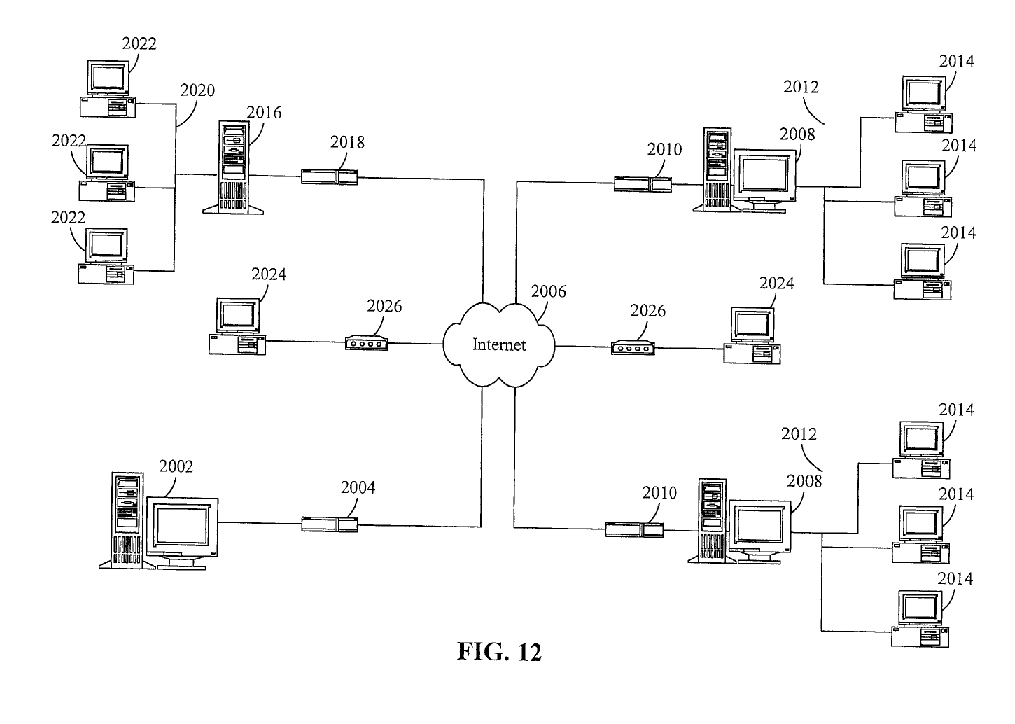

FIG. 12 is a block diagram of a hardware environment in which the various embodiments of the present invention may be implemented. A web site at which communications between consumers and one or more businesses are facilitated according to the invention is located on a server 2002, which is connected by a router 2004 to the Internet 2006. For instance, the web site may be one main web site designed to process orders for multiple businesses, or may be a web site specifically designed for a particular business. One or more businesses (represented by servers 2008) may also be connected to the Internet via routers 2010 in order to receive the transmission of orders from the server 2002. Business servers 2008 may have networks 2012 associated therewith interconnecting a plurality of gateways (e.g., personal computers or work stations) 2014. This enables the present invention to be used among various departments (e.g., billing departments) to expedite order processing. Customers such as consumers, retailers, and resellers (represented by computers 2022 and 2024) may be connected to the Internet in a variety of ways. For example, a customer may be connected from his home via a modem 2026, or from his workplace via a network 2020, a file server 2016, and a router 2018. It will be understood that, according to various embodiments of the invention, customers may gain access to the web site on server 2002 via a variety of hardware configurations. Similarly, businesses may be coupled to the web site on server 2002 in order to receive the transmission of communications (e.g., orders) as well as data from the web site. For example, a business may consist of an individual on his home computer 2024. Similarly, a customer may be an employee who accesses the web site from his computer 2014 at his place of employment, which is a business. It will also be understood that the hardware enviromnent of FIG. 12 is shown for illustrative purposes and that a wide variety of hardware environments may be employed to implement the various embodiments of the present invention. It should also be understood that specific embodiments of the methods and processes described herein are implemented as computer program instructions, i.e., software, in the memory of server 2002.

Various embodiments of the invention can also be embodied as computer readable code on a computer readable medium. The computer readable medium is any data storage device that can store data, which can thereafter be read by a computer system. Examples of the computer readable medium include read-only memory, random-access memory, CD-ROMs, magnetic tape, and optical data storage devices.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is described in the context of a computer system. However, it should be understood that the present invention is not limited to this arrangement, but instead would equally apply regardless of the type hardware configuration. For instance, although the present invention is described as being implemented via a web site on the Internet, the present invention may be implemented within any network configuration. Moreover, the present invention may be used to process an order received from a reseller or retailer as well as a consumer. In addition, the process manager may be implemented in a variety of ways to process order information and gateway information to enable an order to be processed by multiple gateways. In addition, although an order is described above as identifying products, a customer may also submit an order for services. Accordingly, the present embodiments are to be considered as illustrative and not restrictive, and the invention is not to be limited to the details given herein, but may be modified within the scope and equivalents of the appended claims. in the sequence of gateways may be configured to simultaneously process or sequentially process the order information received by them. In the example illustrated in FIG. 1, gateways 110, 112, 114, and 116 are configured to simultaneously process the order information received by them. Each of the gateways is configured for processing a specific set of order information (e.g., fields), which may be a subset of the order or equivalent to the entire order. For example, a gateway that is located in the billing department will require information that is necessary for billing the customer such as customer name, credit card number, expiration date, and total purchase amount. Moreover, the order information processed by each of the gateways 110, 112, 114, and 116 may be identical or different. For example, all gateways will need information that identifies the order (e.g., order number) while other information required by each gateway may differ. The order information that is required by each gateway may be identified by a “rule” associated with the particular gateway or may simply be parameters of the gateway.

Even when an order is “split,” some of the gateways will be configured for sequential processing while others will be configured for parallel processing. In accordance with the present invention, two or more gateways (e.g., 110, 112, 114, and 116) in the chain of gateways are identified (e.g., for parallel processing). More particularly, a first gateway (e.g., 110) has a first set of fields (e.g., parameters) associated therewith and a second gateway (e.g., 112) has a second set of fields (e.g., parameters) associated therewith. When a calling gateway calls these two gateways, the associated set of field values is passed as parameters to enable these gateways to separately process at least a portion of the order. It is important to note that the present invention enables parallel processing by multiple gateways. Thus, a single

What is claimed is:

1. A computer implemented method for processing an order within a network, comprising:
receiving an order at an initial gateway, the order having a plurality of fields associated therewith;
ascertaining a chain of a plurality of gateways for processing at least a portion of the order, the chain of gateways identifying a sequence in which the gateways are configured to process the order;
identifying a first gateway in the chain of gateways, the first gateway being adapted for processing a first set of one or more fields of the order;
identifying a second gateway in the chain of gateways, the second gateway being adapted for processing a second set of one or more fields of the order;
passing the first set of fields to the first gateway; and
passing the second set of fields to the second gateway, thereby enabling the first and second gateways to separately process at least a portion of the order.

2. The method as recited in claim 1, wherein passing the first set of fields and the second set of fields is performed from a calling gateway, and passing the second set of fields is performed prior to completion of processing of the first set of fields by the first gateway, thereby enabling the first and second gateways to simultaneously process at least a portion of the order.

3. The method as recited in claim 1, wherein the first gateway is associated with a first business location and the second gateway is associated with a second business location.

4. The method as recited in claim 1, wherein the first gateway is associated with a first department within a business location and the second gateway is associated with a second department within the business location.

5. The method as recited in claim 1, wherein the calling gateway is one of the plurality of gateways.

6. The method as recited in claim 1, wherein the calling gateway is the initial gateway.

7. The method as recited in claim 1, wherein each of the plurality of gateways in the chain of gateways is linked to one or more of the plurality of gateways.

8. The method as recited in claim 1, wherein at least one of the first and second gateways has an associated set of one or more conditions that must be fulfilled prior to passing the associated set of fields to the corresponding gateway.

9. The method as recited in claim 8, wherein the set of one or more conditions depend upon the content of the order.

10. The method as recited in claim 9, wherein the content of the order includes at least one of order quantity, customer, name, customer address, credit card type, card expiration date, item ordered, quantity of item ordered, item price, and total price of items ordered.

11. The method as recited in claim 1, wherein the first set of fields is equivalent ot the second set of fields.

12. The method as recited in claim 1, wherein the first set of fields is different from the second set of fields

13. The method as recited in claim 1, wherein at least one of the first set of fields and the second set of fields are subsets of the order.

14. The method as recited in claim 1, wherein when at least one of the first and second gateways does not have an associated set of one or more conditions that must be fulfilled prior to passing the associated set of fields to the corresponding gateway, the associated set of fields includes all fields in the order.

15. The method as recited in claim 8, wherein the set of one or more conditions correspond to at least one of an order item, order characteristics, location from which an order item is to be processed, customer profile, and payment method.

16. The method as recited in claim 8, one or more of the plurality of fields having a field indicator identifying the field within the order, the method further comprising:
obtaining one or more field values corresponding to the set of conditions using the associated field indicators; and
determining from the obtained field values whether the set of conditions is fulfilled.

17. The method as recited in claim 16, wherein each field indicator identifies a field position within the order.

18. The method as recited in claim 16, wherein each field indicator identifies a field name.

19. The method as recited in claim 1, wherein the chain of gateways is represented by one or more gateway tables, each of the gateway tables associating a gateway with one or more linked gateways that are configured for processing upon completion of processing by the gateway.

20. The method as recited in claim 19, wherein each of the linked gateways is associated with a status indicating that the gateway is pending, processing or done processing.

21. The method as recited in claim 8, wherein the set of conditions requires that the corresponding gateway wait for completion of processing of a set of one or more processing gateways.

22. The method as recited in claim 1, wherein the chain of gateways is defined through a customizer module.

23. The method as recited in claim 1, wherein the chain of gateways is modifiable.

24. The method as recited in claim 1, wherein the chain of gateways is defined by a business through which the order is to be processed.

25. The method as recited in claim 8, wherein the set of conditions is defined through a customizer module.

26. The method as recited in claim 8, wherein the set of conditions is modifiable.

27. The method as recited in claim 8, wherein the set of conditions is defined by a business through which the order is to be processed.

28. A computer implemented method for processing an order within a network, comprising:
receiving an order at an initial gateway, the order having a plurality of fields;
ascertaining a chain of a plurality of gateways for processing the order, the chain of gateways identifying a sequence in which the gateways are configured to process at least a portion of the order;
identifying a gateway in the chain of gateways for processing a set of one or more fields of the order such that the set of fields can be passed to the identified gateway, the gateway having an associated set of one or more conditions that must be fulfilled prior to passing the associated set of fields to the identified gateway;
determining whether the conditions associated with the identified gateway are fulfilled; and
passing the set of fields to the identified gateway when it is determined that the conditions associated with the identified gateway are fulfilled, thereby enabling the identified gateway to process at least a portion of the order.

29. The method as recited in claim 28, wherein the set of one or more conditions depend upon the content of the order.

30. The method as recited in claim 29, wherein the content of the order includes at least one of order quantity, customer, name, address, credit card type, card expiration date, item ordered, quantity of item ordered, item price, and total price of items ordered, a catalog identifier, supplier discount offers, supplier promotional information, tax rate, and shipping details.

31. The method as recited in claim 28, wherein the set of one or more conditions correspond to at least one of an order item, order characteristics, location from which an order item is to be processed, customer profile, and payment method.

32. The method as recited in claim 28, wherein the set of conditions is modifiable.

33. The method as recited in claim 28, wherein the set of conditions is defined by a business through which the order is to be processed.

34. A computer implemented method for processing an order within an network, comprising:
receiving an order at an initial gateway, the order having associated order information;
ascertaining a chain of a plurality of gateways for processing the order, the chain of gateways identifying a sequence in which the gateways are configured to process at least a portion of the order;
examining gateway information associated with the chain of gateways to identify one or more gateways that are available for processing; and
passing at least a portion of the order information to the identified available gateways, thereby enabling the identified available gateways to process at least a portion of the order.

35. The method as recited in claim 34, wherein examining the gateway information comprises:
determining whether one or more gateways in the chain of gateways have one or more conditions associated therewith that must be fulfilled prior to accessing the associated gateway; and
ascertaining whether the conditions are fulfilled.

36. The method as recited in claim 34, the gateway information indicating a status for each one of the plurality of gateways, the status indicating whether the corresponding gateway is available for processing.

37. The method as recited in claim 36, wherein when the status indicates that a corresponding gateway is available for processing, the gateway has no conditions that must be fulfilled prior to accessing the gateway or the gateway has one or more conditions that have been fulfilled.

38. The method as recited in claim 36, wherein the chain of gateways is defined by a business through which the order is to be processed.

39. The method as recited in claim 36, further comprising:
associating a pending status with the initial gateway such that a new order can be received by the initial gateway.

40. The method as recited in claim 36, further comprising:
marking a status of the identified available gateways as processing.

41. The method as recited in claim 36, further comprising:
passing at least a portion of the gateway information to the identified available gateways.

42. The method as recited in claim 36, wherein the gateway information is represented by one or more gateway tables, each of the gateway tables associating a gateway with zero or more linked gateways, each of the linked gateways being associated with a status.

43. The method as recited in claim 42, wherein the gateway associated with the one or more linked gateways has a status associated therewith.

44. The method as recited in claim 42, wherein passing at least a portion of the gateway information to the identified available gateways comprises:
passing one of the gateway tables to each of the identified available gateways.

45. The method as recited in claim 42, wherein the status indicates that the gateway is pending, processing or done processing.

46. The method as recited in claim 45, wherein examining gateway information associated with the chain of gateways to identify one or more gateways that are available for processing comprises:
sweeping the gateway tables to identify one or more gateways having a pending status.

47. The method as recited in claim 46, wherein examining gateway information associated with the chain of gateways to identify one or more gateways that are available for processing further comprises:
determining whether each of the identified gateways is available to process an event.

48. The method as recited in claim 34, wherein the order information is stored in one or more process manager tables.

49. The method as recited in claim 48, further comprising:
populating the process manager tables with the order information after receiving the order.

50. The method as recited in claim 48, wherein passing at least a portion of the order information to the identified available gateways comprises:
identifying one or more parameters of each of the identified available gateways;
obtaining the identified one or more parameters for each of the identified available gateways from the one or more process manager tables; and
passing the obtained parameters to the identified available gateways.

51. The method as recited in claim 48, further comprising:
when one of the identified available gateways modifies the order information, storing modified order information in the process manager tables.

52. The method as recited in claim 36, further comprising:
modifying the status of the current processing gateway to done.

53. The method as recited in claim 44, further comprising:
for each of the linked gateways in the gateway table, determining whether one or more conditions must be fulfilled prior to accessing the linked gateway; and
for each of the linked gateways determined to have one or more conditions associated therewith, determining whether the conditions are fulfilled.

54. The method as recited in claim 53, further comprising:
for each of the linked gateways not having one or more associated conditions and for each of the linked gateways for which the associated conditions are fulfilled, creating a new gateway table and marking the status of the linked gateway as pending.

55. The method as recited in claim 53, wherein the one or more conditions depend upon the content of the order.

56. The method as recited in claim 53, wherein the one or more conditions associated with a linked gateway correspond to at least one of an order item, order characteristics, location from which an order item is to be processed, customer profile, and payment method.

57. The method as recited in claim 53, wherein the one or more conditions associated with a linked gateway requires that the linked gateway wait for completion of processing of a set of one or more processing gateways.

58. The method as recited in claim 53, wherein the conditions are defined by a business through which the order is to be processed.

59. A computer implemented method for processing an order by a receiving gateway within a network, comprising:
obtaining gateway information associated with the order, the gateway information indicating a status for one or more linked gateways, the status indicating whether the linked gateway is available for processing upon completion of processing of an associated processing gateway;
examining a set of conditions associated with each of the linked gateways to identify one or more of the linked gateways that are available for processing; and
updating the gateway information associated with the processing gateway and the linked gateways.

60. The method as recited in claim 59, wherein the receiving gateway is an acknowledging gateway.

61. The method as recited in claim 59, wherein the receiving gateway is the processing gateway.

62. The method as recited in claim 59, wherein obtain gateway information comprises receiving the gateway information from the processing gateway.

63. The method as recited in claim 59, further comprising:
when the processing gateway modifies the order information, storing the modified order information.

64. The method as recited in claim 59, wherein updating the gateway information comprises:
modifying the status of the processing gateway to done.

65. The method as recited in claim 59, wherein examining a set of conditions associated with each of the linked gateways to identify one or more of the linked gateways that are available for processing comprises:
for each of the linked gateways, determining whether one or more conditions must be fulfilled prior to accessing the linked gateway; and
for each of the linked gateways determined to have one or more conditions associated therewith, determining whether the conditions are fulfilled.

66. The method as recited in claim 59, wherein the gateway information is represented by one or more gateway tables, wherein updating the gateway information comprises:
for each of the linked gateways not having one or more associated conditions and for each of the linked gateways for which the associated conditions are fulfilled, creating a new gateway table and marking the status of the linked gateway as pending.

67. A computer-readable medium for processing an order within a network, the computer-readable medium storing thereon the following instructions:
instructions for receiving an order at an initial gateway, the order having a plurality of fields associated therewith;
instructions for ascertaining a chain of a plurality of gateways for processing at least a portion of the order, the chain of gateways identifying a sequence in which the gateways are configured to process the order;
instructions for identifying a first gateway in the chain of gateways, the first gateway being adapted for processing a first set of one or more fields of the order;
instructions for identifying a second gateway in the chain of gateways, the second gateway being adapted for processing a second set of one or more fields of the order;
instructions for passing the first set of fields to the first gateway; and
instructions for passing the second set of fields to the second gateway, thereby enabling the first and second gateways to separately process at least a portion of the order.
